(19) United States
(12) Patent Application Publication
(10) Pub. No.: US 2016/0297990 A1
(43) Pub. Date: Oct. 13, 2016

(54) CROSSLINKABLE COMPOSITIONS OF 2K POLYURETHANES WITH LOW VOC CONTENT

(71) Applicant: ARKEMA FRANCE, Colombes (FR)

(72) Inventors: Aurelie PIERRE, Paris (FR); Gregory A. DELMAS, Senlis (FR)

(21) Appl. No.: 15/037,133

(22) PCT Filed: Nov. 13, 2014
(86) PCT No.: PCT/FR2014/052892

§ 371 Date: May 17, 2016

(30) Foreign Application Priority Data
Nov. 18, 2013 (FR) 1361269

(51) Int. Cl. C09D 175/06; C08G 18/73; C08G 18/62

(52) U.S. Cl. CPC C09D 175/06; C08G 18/6229; C08G 18/73

(57) ABSTRACT

The present invention relates to a polyol resin composition comprising an acrylic polyol resin obtained from a monomer mixture comprising a1) at least one hydroxylated ethylenically unsaturated monomer or a monomer that is a precursor of a hydroxylated unit and a2) at least one cycloaliphatic ethylenically unsaturated monomer, b) a diluent bearing at least two groups that are reactive with an isocyanate group, c) a urethanization reaction catalyst, optionally d) at least one inert diluent or monofunctional reagent with a boiling point below 250° C. and optionally at least one additive from among: UV stabilizer, antioxidant, pot life extender, conductivity additive, the composition having a VOC content <300 g/l at a reference application viscosity of 450 mPa·s at 25° C.

The present invention relates first to a specific polyol resin composition which may be used as a component that is reactive with a polyisocyanate in a polyurethane crosslinkable composition, in particular a polyurethane two-pack crosslinkable coating composition with a low content of volatile organic compounds, in particular <250 g/l at an application viscosity taken as reference of 450 mPa·s at 25° C., without any significant change in the level of final application performance qualities, and also relates to a polyurethane crosslinkable composition, in particular a coating composition, comprising said resin composition, and also to the use of said composition for said polyurethane coatings.

Said viscosity of 450 mPa·s is not a limitation of the viscosity of the coating composition, but a viscosity serving as reference for the present invention to determine the associated content of volatile organic compounds (VOCs) as defined below.

According to the present invention, the term “VOC” means volatile organic compounds that meet the following criteria for the needs of the present invention: having a boiling point (b.p.) at atmospheric pressure of <250° C. and selected from inert or unreactive diluents, i.e. (unreactive) not bearing any group capable of reacting with an isocyanate, or from reactive monofunctional diluents bearing a group capable of reacting with an isocyanate group.

In order to anticipate the application of increasingly stringent future regulations in terms of health and environmental protection, the contents of volatile organic compounds VOCs must be increasingly low for applications in organic solvent medium. This is why the industrial coatings market is increasingly focused on new developments regarding solvent-based formulations (organic solvent medium) with a very high dry extract (or solids content) allowing such requirements to be met. In the context of the present invention, coating compositions with a content of VOCs, as defined above, of less than 250 g/l at a reference application viscosity of 450 mPa·s at 25° C. are targeted in particular.

In the United States, this target may be achieved by using acetone as dilution solvent, which is exempt from the VOC regulation in the USA. However, since the industrial protective coatings market needs to be considered in an international context, a global solution that is capable of meeting all the requirements of the international market, in particular the European market where the regulation is more stringent in the definition of VOCs, for example with acetone being included in the definition of VOCs, must be envisaged.

Decreasing the contents of VOCs in coating compositions has been the subject of numerous patents for many years. For example, WO 01/38415 describes a polyurethane coating composition with a low level of VOC and a good level of performance in terms of initial hardness and chemical resistance, for application in the field of vehicles. However, the compositions described have VOC contents much higher than 250 g/l.

Similarly, EP 1 178 080 describes compositions based on polyol resins, but with VOC contents of greater than 250 g/l.

U.S. Pat. No. 6,015,871 describes a thermosetting composition with a high dry extract based on a polyol resin and the presence of a reactive diluent, for coatings with good durability, a high level of gloss and good chemical resistance with a low level of VOC. However, said low level of VOC described does not take into account the content of volatile solvents such as acetone and thus the effective VOC content according to the definition given above is much higher than 250 g/l.

The composition of the present invention makes it possible to limit the use of VOCs according to the definition given above, such as acetone, while at the same time maintaining a performance level equivalent to the performance level of formulations “with a high standard dry extract” having a VOC content of about 420 g/l. The invention lies in the selective combination of the three essential components: a specific solvent-based (in organic solvent medium) polyol acrylic resin, a specific diluent that is reactive with isocyanate and a catalytic system for reaction with a polyisocyanate component, which in particular is also specifically selected. In the absence of said selective combination, the targeted VOC level cannot be reached, and nor can the properties required for the industrial protective coating market.

The coating formulation which is based on said composition of resin and of a selected polyisocyanate in particular specifically has a content of VOCs as defined above of less than 250 g/l at a reference (application) viscosity of 450 mPa·s at 25° C. and has application performance qualities in terms of drying and of development of hardness at least equivalent to the standard “high dry extract” systems which have a higher content of volatile organic compounds, corresponding in particular (current “high dry extract” systems) to a VOC level of 420 g/l at the reference (application) viscosity. Specifically, decreasing the VOC level of a formulation is generally achieved by decreasing the molecular masses of the resin, but thus leads to deterioration of the properties of the coating, such as the drying rate, the development of hardness, the chemical resistance, the durability and the mechanical performance. Dilution with volatile inert diluents (b.p. <250° C. at atmospheric pressure) increases the VOC content and the risks to health and to the environment. Moreover, the use of monofunctional diluents that are reactive with isocyanates and volatile, for example light monoalcohols, despite the possibility of reducing the viscosity of the formulation and the possibility of reacting with isocyanate, first does not reduce the risk to the environment and to health (since they are volatile) and above all deteriorates the mechanical performance by reducing the degree of crosslinking (blocking agent versus polyisocyanates) and in addition has as a negative effect the overconsumption of polyisocyanates. By limiting these volatile diluents and by the specific choice of the components of the resin composition and of the polyisocyanate of the crosslinkable composition, the present invention makes it possible to overcome the drawbacks of the solutions of the prior art with a very good compromise in the production of an industrial protective coating composition, with a very low VOC content and at the same time a performance level at least equivalent to that of the systems currently known with a higher VOC content and thus without significantly affecting the final application performance qualities.

More particularly, the present invention makes it possible, according to a particular mode, to improve the pot life of the coating composition. Since the catalyst is present in the composition, it makes it possible to accelerate the reaction and thus to increase the rate of crosslinking during the application and thus the drying rate. However, it simultaneously reduces the pot life of the crosslinkable composition, in particular a coating and more particularly a varnish, paint, lacquer or ink composition. Even more particularly, the present invention also makes it possible, by encapsulation, in particular nanoencapsulation of the urethanization catalyst, to increase the pot life. The principle of encapsulation of the catalyst consists in coating (trapping) the catalyst in nanocapsules that are present in the coating composition with said polyol resin composition. These nanocapsules thus make it possible, according to this particular mode, to mask (block) the activity of the catalyst during the formulation and thus to not catalyze in the pot the reaction of the polyol resin and of said diluent that is reactive with polyisocyanate, said nanocapsules then releasing said catalyst, for example by rupture during the passage of the formula through the nozzle of the application gun especially at high shear. The drying properties are thus conserved and the pot life is extended. To do this, the nanocapsules must have a particular structure and size allowing good stability with respect to shear during the steps of preparation of the resin and of formulation, but, by principle, a low resistance to the higher shear the application gun. Moreover, the nanocapsule must not be permeable, so as to avoid diffusion of the catalyst during the time of storage of the resin, but also of the formulation. Thus, this particular variant of the invention also makes it possible to increase the pot life of the formulation and thus to adjust it to the final application conditions.

The present invention first covers a specific polyol resin composition based on a mixture of ethylenically unsaturated monomers, in particular acrylic polyol resin allowing the use of a crosslinkable polyurethane composition with a low VOC content and <250 g/l.

Next, the invention relates to a crosslinkable composition based on said resin composition and on a polyisocyanate.

Another subject of the invention concerns a coating composition based on said resin composition and more precisely based on said crosslinkable composition.

The use of said resin composition as a component that is reactive with a polyisocyanate, for two-pack (2 k) polyurethane coatings with a low VOC content and <250 g/l, also forms part of the invention.

Finally, the invention also covers the crosslinked polyurethane finished product in particular in the form of a coating, resulting from said use.

Thus, the first subject of the present invention relates to a polyol resin composition, which is in particular capable of reacting with an isocyanate, which resin composition comprises the following components:
a) at least one polyol resin, in particular an acrylic resin, obtained by polymerization of a mixture of ethylenically unsaturated monomers comprising a1) at least one hydroxylated ethylenically unsaturated monomer, in particular an acrylic monomer or a monomer that is a precursor of a hydroxylated unit, chemically modified during said polymerization or after, and a2) at least one ethylenically unsaturated monomer, in particular an acrylic monomer, of cycloaliphatic structure and said resin a) having the following characteristics:
   an OH number ranging from 50 to 200, preferably from 50 to 175 mg KOH/g (g here means g of dry resin)
   an acid number <15, preferably <10 and more preferentially <5 mg KOH/g
   a Tg calculated according to Fox of greater than 25° C., preferably from 30 to 90° C.
   an Mn ranging from 1000 to 4000
b) at least one reactive diluent bearing per molecule at least two groups, preferably from 2 to 4 and more preferentially from 2 to 3 groups that are capable of reacting with an isocyanate group
c) at least one urethanization reaction catalyst, optionally in the presence of a cocatalyst, in particular c) being nanoencapsulated, preferably c) being free of tin
d) optionally, at least one diluent with a boiling point (b.p.) of less than 250° C. at atmospheric pressure, which is chosen from inert or unreactive diluents (i.e. not bearing any group that can react with an isocyanate) or from reactive monofunctional diluents bearing a group that can react with an isocyanate group, in particular said diluent d) being the residual polymerization solvent for said resin a)
e) optionally, at least one additive from among: UV stabilizer, antioxidant, pot life extender, conductivity additive or corrosion inhibitor
   with said composition having a content of compound d) corresponding to the content of volatile organic compounds (VOC) of less than 300 g/l at 450 mPa·s at 25° C.

The Mn (number-average molecular mass), and similarly the other molecular masses cited, are given in g/mol (or daltons). The OH number or the acid number in mg KOH/g are given relative to the dry resin (per g of dry resin).

The Mn of said resin a) is measured by GPC (or SEC) in THF as polystyrene equivalents, used as standard.

Preferably, the weight content of said monomer of cycloaliphatic structure a2) is at least 5% and less than 80% by weight relative to the total weight of the monomers of said resin a).

In particular, said reactive diluent b) has a Tg measured by DSC and more precisely at 10° C./min after 2 passes, of less than −50° C., preferably ranging from −100 to less than −50° C. and more preferentially from −90° C. to less than −50° C.

More particularly, said diluent b) is present in a content such that the percentage weight ratio of b/(a+b+c+d+e) ranges up to 60%, preferably up to 50%, more preferentially from 5% to 50% with the sum of a)+b)+c)+d)+e) being equal to 100%. More particularly, said reactive diluent b) has a molecular mass that does not exceed 1000 and a (number-) average functionality ranging from 2 to less than 4, preferably from 2 to 3 and more preferentially between 2 and 2.75. Said molecular mass of said diluent b) corresponds either to the molar mass that may be calculated from a precise (empirical) formula or by the known equivalent mass and the known functionality, or measured by GPC (or SEC) in THF and expressed as polystyrene equivalents and, in this case, it corresponds to the number-average molecular mass Mn, for instance that measured in the case of said polyol resin, in particular acrylic resin, a).

Said polyol resin, in particular acrylic resin, a), is more particularly a copolymer derived from the radical polymerization in a diluent d) of a mixture of ethylenically unsaturated monomers, comprising, in addition to a1) and a2) as defined above, a3) at least one comonomer selected from the other ethylenically unsaturated monomers, in particular from (meth)acrylic monomers and/or vinyl monomers, preferably said monomer mixture being based on (meth)acrylic monomers. The term “acrylic polyol” means that it comprises at least one “acrylic” monomer with “acrylic” meaning both acrylates or methacrylates, or mixtures thereof:

As monomers a1), mention may be made of: hydroxyalkyl (meth)acrylates with C₁ to C₄ alkyl, optionally alkoxylated, such as 2-hydroxyethyl acrylate, 2-hydroxyethyl methacrylate, hydroxypropyl methacrylate or hydroxybutyl acrylate.

As monomers that are precursors of a hydroxylated unit, examples that may be mentioned include carboxyl monomers such as (meth)acrylic, maleic, fumaric, itaconic or tetrahydrophthalic acid, which are modified, either during polymerization, or after polymerization, with a monoepoxide compound, forming as hydroxylated unit a hydroxy ester, with the hydroxyl in the alpha position relative to said ester. Similarly, said precursor monomer may be an epoxidized monomer, with modification of said epoxy during polymerization or after by reaction with a monoacid and giving as hydroxylated unit in said polyol resin a hydroxy ester analog unit. Similarly, the precursor monomers may be monomers comprising an amine function that can react analogously with a monoepoxidized compound to give as hydroxylated unit a hydroxy amine adduct on said epoxy.

As monomers a2) that are suitable for use, mention may be made of: norbornyl, isobornyl, isophoryl, cyclohexyl, dicyclopentadienyl, decahydronaphthalenyl (meth)acrylates.

As monomers a3) that are suitable for use, mention may be made of: (meth)acrylic esters derived from a C₁ to C₁₈ and preferably C₁ to C₁₂ aliphatic alcohol, vinyl monomers, preferably C₁ to C₁₈ esters of vinyl alcohol.

In the resin composition according to the invention, said polyol resin a) is preferably present in a content such that the a/(a+b+c+d+e) weight ratio ranges from 40% to 90% and preferably from 50% to 90% with the sum of a)+b)+c)+d)+e) being equal to 100%.

Said reactive diluent b) may be selected from:
b1) polyol alkanes or polyamine alkanes bearing a linear or branched chain, which are alkoxylated or non-alkoxylated, preferably with a chain length of C₂ to C₅₄, more preferentially C₁₂ to C₅₄ polyols
b2) polyols derived from natural oils or derivatives of the corresponding fatty acids, in particular with a chain length ranging from C₁₂ to C₅₄
b3) polyol oligoethers or oligoimine polyamines
b4) polyol oligoesters, in particular based on caprolactone or neodecanoic acid glycidyl ester, in particular known under the trade name Cardura® E10 sold by Momentive
b5) polyol oligourethanes
b6) polyoxazolidines, in particular bisoxazolidines
   preferably the diluent b) is chosen from b2) and/or b3) and/or b6).

As regards said catalyst c), it may be chosen from:
c1) metal salts or metal complexes based on metals chosen from: Bi, Ti, Zn, Zr, Sn, preferably Bi, Ti, Zn, Zr
c2) tertiary amines
   and preferably c) is chosen from c1) metal salts or complexes of Ti or of Zr and from c2) tertiary amines.

As regards said diluent d), it may be chosen from:
d1) C₂-C₄ acid monoesters with alcohols (linear or branched), in particular ethyl acetate, butyl acetate, isoamyl acetate, pentyl acetate, ethyl 3-ethoxypropionate or 1-methoxy-2-propyl acetate
d2) dicarboxylic acid diesters with C₁-C₄ alcohols, in particular esters of adipic, glutaric and succinic acids with methanol, ethanol, (iso)propanol or (iso)butanol
d3) ketones, in particular acetone, butanone, methyl ethyl ketone, methyl amyl ketone, methyl isobutyl ketone, cyclohexanone, isophorone
d4) aromatic solvents, in particular heavy or light petroleum fractions having respective boiling point ranges of 180-215° C. and 150-180° C., toluene and xylene and isomers thereof
d5) other aliphatic solvents such as alkanes of at least C₆, for instance hexane, heptane or octane
d6) mixed solvents, i.e. solvents comprising heteroatoms, in particular dimethyl sulfoxide (DMSO), N-ethylpyrrolidone (NEP), tetrahydrofuran (THF)
d7) monofunctional alcohols with a boiling point of <250° C., in particular butanol, propanol, isopropanol, C₂ to C₄ diol monoethers with a C₁ to C₄ alcohol, such as 2-butoxyethanol, said alcohols d7) being present only as a mixture with at least one other diluent d) and not representing more than 10% and preferably not more than 5% of the total weight of d)
d8) a binary or ternary mixture of said solvents mentioned above, d1) to d7) provided that there is compatibility between said solvents and also between said mixtures of solvents and the other components of said resin composition.

The compatibility between diluents d) as described above means the absence of demixing at room temperature which corresponds to the temperature of use.

The polyol resin a) may also be characterized by a viscosity of from 500 to 5000 mPa·s at 25° C. for a weight content of said resin a) of 70% (±1%) relative to the total resin+solvent, preferably said solvent being as defined according to d), in particular according to d1) and more particularly butyl acetate.

The second subject of the invention concerns a crosslinkable polyurethane composition, which crosslinkable composition comprises:
A) at least one polyol resin composition as defined above according to the invention, as component that is reactive with a polyisocyanate B) as defined below
B) at least one polyisocyanate with a functionality (number-average) of NCO groups of at least 2, preferably greater than 2, more preferentially between 2 and 4, said polyisocyanate being optionally blocked and/or encapsulated,
   and preferably the proportions of A) and B) being such that the ratio of the total number f of the reactive 01H functions of a) and of the functions of b) that are reactive with NCO to the total number of isocyanate functions NCO (f/NCO) ranges from 0.8 to 1.3 and preferably from 0.9 to 1.1.

The number-average functionality is in particular valid if it concerns a mixture of polyisocyanate prepolymers.

A blocked polyisocyanate means an isocyanate whose NCO functions are blocked with a labile blocking agent, under the application conditions or the final use conditions of the composition. An example of a suitable blocking agent that may be mentioned is methyl ethyl ketone oxime.

An encapsulated polyisocyanate means that it is contained in microcapsules and preferably nanocapsules that are gradually soluble in the solvent medium of the crosslinkable composition and thus gradually release said polyisocyanate and allow control of the pot life as a function of the final use. The nanocapsules containing said polyisocyanate may also break by mechanical shear of the wall, for example during the application of said composition by means generating such a high shear, for instance during application by spraying with a gun. The microencapsulation techniques and in particular the techniques for preparing microencapsulated reactive or unreactive components are well known to those skilled in the art in the various reactive or unreactive formulations. For example, the document Macromolecules 2008, 41, 9650-9655 describes the encapsulation of polyisocyanates, in particular for use in self-healing polymers.

The crosslinkable composition according to the invention in particular has a content of compounds d) corresponding to the content of volatile organic compounds (VOC) as defined according to the invention which is less than 250 g/l.

Still concerning said crosslinkable composition, said polyisocyanate B) may be selected from aliphatic or cycloaliphatic polyisocyanates, in particular allophanate-modified polyisocyanates. The term “allophanate-modified” means herein comprising at least one allophanate group. Allophanate in fact results from the reaction of an isocyanate with a urethane, obtained by reaction between an alcohol and an isocyanate, thus leading to the grafting of said isocyanate onto said urethane in allophanate form by reaction with an NH group of said urethane.

Said polyisocyanate may, according to a variant, comprise an isocyanurate ring.

According to a particular mode, said polyisocyanate is of aliphatic structure and it may be, inter alia, an allophanate-modified polyisocyanate.

More particularly, said polyisocyanate B) is an allophanate-modified polyisocyanate, with a structure according to the general formula (I) below:

O═C═N—R₁—N(R₂)—C(═O)—NH—R₁—N═C═O (I)

with
R₁: C₆ alkylene or cycloalkylene, preferably C₆ alkylene
R₂: —C(═O)—OR₃, with R₃ being a C₆ to C₃₆ alcohol residue, preferably a C₁₂ to C₃₆ fatty alcohol.

According to another possibility, said polyisocyanate is of cycloaliphatic structure.

The third subject of the invention concerns a coating composition which comprises at least one crosslinkable polyurethane composition as defined above according to the invention. Preferably, said composition is a protective or decorative coating composition. More particularly preferably, this composition is a paint, varnish, lacquer or ink composition. Said coating composition may comprise, in addition to said crosslinkable composition, pigments that may be organic or inorganic, mineral fillers, in particular CaCO₃, BaSO₄, silica, alumina, talc or rheology additives, wetting agents, dispersants, surface agents, UV stabilizers and, in this case, in addition to those (UV stabilizers) present with said polyol resin composition or antioxidants, corrosion inhibitors, moisture absorbers such as alkoxysilanes, or antifoams.

According to a particularly preferred variant, said coating composition according to the invention concerns metal anticorrosion coatings.

Another subject of the present invention relates to the use of a composition as defined above according to the invention, as component that is reactive with a polyisocyanate, in crosslinkable polyurethane coating compositions, with a content of VOCs as defined above and according to the invention, of said coating composition less than 250 g/l. According to a particular preference, said use is for protective or decorative coatings of substrates. Said substrates may be chosen from: metal, glass, plaster, concrete, composite, plastic, wood including agglomerate, cardboard, bitumen, fibers or textile.

The substrates cover, inter alia, use for protecting silvering (thin silver coat or coating) supported by glass in the case of a silvered mirror or by another silvered support for the same reasons of protection, in particular anticorrosion (prevention of oxidation) of silver.

Finally, the invention also covers a finished product which is in particular a crosslinked polyurethane, more particularly in the form of a coating, which results from the use of a polyol resin composition or of a crosslinkable composition as defined above according to the invention or of a coating composition as defined above according to the invention.

The example that follows is presented as an illustration of the present invention, without any limitation of its scope.

### EXPERIMENTAL SECTION

### 1) Starting Materials Used and Origin: See Table 1

TABLE 1
list of starting materials used

| | Abbreviated | | |
|---|---|---|---|
| Chemical name or | name used | | |
| trade name of | in the | | Function in the resin |
| product | description | Supplier | composition |
| Styrene | STY | Total | Monomer a3) of polyol a) |
| Butyl acrylate | BuA | Arkema | Monomer a3) of polyol a) |
| Isobornyl | ISOBORMA | Evonik | Monomer a2) of polyol a) |
| methacrylate | | | |
| Hydroxypropyl | HPMA | Evonik | Monomer a1) of polyol a) |
| methacrylate | | | |
| Methacrylic acid | MAA | Arkema | Monomer a3) of polyol a) |
| Luperox ® DI | DTBP | Arkema | Radical generator |
| Butyl acetate | — | Brenntag | Diluent d1) |
| Polycin ® D-290 | — | Vertellus | Reactive diluent b2) |
| TIB KAT 218 | DBTDL | TIB | Catalyst c1) |
| | | Chemicals | |
| Tolonate ® | — | Vencorex | Polyisocyanate crosslinking |
| HDT-LV2 | | | agent with isocyanurate |
| | | | ring (HMDI trimer) |
| | | | with weight % NCO = 23 |

The characteristics of Polycin® D-290, a polyol derived from castor oil, are given in Table 2 below.

TABLE 2
characteristics of the reactive diluent Polycin ® D-290

| Characteristics | Polycin ® D-290 |
|---|---|
| Solids content (%) | 100 |
| OH Functionality | 2 |
| Equivalent weight (g) | 193 |
| Molecular mass (g/mol)* | 386 |
| Tg (° C.)** | −73 |

*obtained by calculation from the data of the commercial technical file
**measured by DSC

### 2) Preparation of the Polyol Acrylic Resin

### Example 1a According to the Invention

Butyl acetate (240 g) is placed in a 2000 mL reactor which can operate under pressure, after inertizing the medium with dinitrogen. The reaction medium is brought to 170° C. The pressure inside the reactor is about 2 bar absolute. In parallel, 491 g of styrene, 264 g of butyl acrylate, 315 g of hydroxypropyl methacrylate, 120 g of isobornyl methacrylate and 9.4 g of methacrylic acid are mixed. A solution of di-tert-butyl peroxide (59.5 g) in butyl acetate (139 g) is also prepared. These two preparations are then introduced in parallel into the reactor over a period of 6 hours, the temperature being maintained at 170° C. throughout the addition. At the end of these additions, the lines for introducing the monomers and the initiator are rinsed with about 42 g of butyl acetate. The medium is maintained at the same temperature for 1 hour, before being cooled to room temperature. The final dry extract of the resin (weight % of solids) measured according to the method ISO 3251 (precisely, 1 g of resin solution) is introduced and spread correctly in an aluminum crucible and the crucible is then placed in an oven at 125° C. and dried for 1 hour. The dry extract, being the percentage of the dry weight thus obtained relative to the initial weight of the resin solution, is then 73.2% and its viscosity corresponding to this dry extract, measured at 25° C. according to standard ISO 3219, is 2440 mPa·s.

TABLE 3
Monomer composition and characteristics
of the polyol acrylic resin a) of the invention

| | Example 1a invention |
|---|---|
| Composition | |
| (weight %) | |
| STY | 40.9 |
| BuA | 22.0 |
| HPMA | 26.3 |
| ISOBORMA | 10.0 |
| MAA | 0.8 |
| Characteristics | |
| Dry extract (%) | 73.2 |
| Viscosity (mPa · s) | 2440 |
| Calculated hydroxyl | 102 |
| functionality | |
| (mg KOH/g) | |
| Acid number | 8.2 |
| (mg KOH/g) | |
| Tg Fox (° C.) | 49 |
| Mn (g/mol) | 1960 |
| Mw (g/mol) | 3560 |

### 3) Preparation of the Polyol Resin Composition

Procedure and compositions prepared and characteristics. See Table 3.

### Example 1b According to the Invention

38.9 g of polyol acrylic resin of Example 1a of the invention are introduced into a mixer. 5.10 g of butyl acetate are added thereto for dilution, followed by 9.49 g of Polycin® D-290. The whole is mixed for 10 minutes. 0.114 g of DBTDL (1.14 g of a 10% solution in butyl acetate) is then introduced.

TABLE 4
Polyol composition, Example 1b according to the invention

| | Example 1b |
|---|---|
| Example 1a (g) | 38.9 |
| Polycin ® D-290 (g) | 9.49 |
| Butyl acetate (g) | 5.10 |
| Catalyst (DBTDL): Solution | 1.14 |
| diluted to 10% in butyl | |
| acetate | |

### 4) Preparation of the Crosslinkable Coating Varnish Formulation

### Example 1c According to the Invention

The formulation of Example 1c is performed by mixing with stirring (disperser), at between 1000-1200 rpm at 23° C. in a metal pot, the required amount of the resin of Example 1b with the required amount of Tolonate® HDT-LV2 (see Table 5). Stirring is maintained for 2 minutes.

TABLE 5
Crosslinkable coating varnish formulation and characteristics

| | Formulation |
|---|---|
| | of Example 1c |
| Example 1b (g) | 54.63 |
| Tolonate ® HDT-LV2 (g) | 17.84 |
| Characteristics | |
| Viscosity (mPa · s) at 25° C. | 304 |
| CAP 1000 (needle No. 3) | |
| Density (g/ml) | 1.01 |
| Calculated dry extract (%) | 77.0 |
| Calculated VOC (g/l) | 232 |

The calculated dry extract corresponds to the solids content (i.e.: 100−weight % of volatile compounds according to d)).

### 5) Tests Used to Evaluate Characteristics of the Composition or the Performance Qualities of the Coating

### 5.1) Measurement of the Viscosity According to Method ISO 3219

The viscosity of the solvent-based resins is measured using a Brookfield LVDV-I+ viscometer, with an S34 spindle, at 25° C.

### 5.2) Measurement of the Acid Number of the Acrylic Polyol Resin According to Method ISO 2114

The acid number is measured by titration of a sample of resin or of composition, of given mass, dissolved in a xylene/2-propanol mixture and supplemented with a few drops of phenolphthalein, which is a colored indicator for identifying the point of equivalence. The titrating solution used is a 0.1 M alcoholic potassium hydroxide solution. The acid number (IA) is expressed in mg KOH/g of dry resin and obtained in the following manner:

$$IA = \frac{C \times {V}_{eq} \times 56.1}{m \times DE} \times 100$$

where C is the concentration of the potassium hydroxide solution in mol/l
V_{eq} is the volume of titrating solution added to equivalence, in ml
56.1 is the molecular mass of potassium hydroxide in g/mol
m is the mass of the sample of resin or of composition, in g
DE is the dry extract or content of resin in weight % relative to the resin solution a) as obtained according to Example 1a.

### 5.3) Hydroxyl Group Functionality (or Hydroxyl Number) of the Polyol Acrylic Resin a), Expressed in mg KOH/g of Dry Resin

It is obtained by calculation from the material balance of the hydroxyl functions incorporated with the monomer bearing said function relative to the weight of all of the monomers constituting said polyol resin a).

### 5.4) Measurement of the Tg

The Tg of the diluent b) is measured by DSC analysis which is performed on a DSC1 Mettler-Toledo machine, with temperature programming at 10° C./min, with a sweep from −130° C. to 0° C. (sweeping under nitrogen). The Tg values retained are those of the second passage.

On the other hand, the Tg of the polyol acrylic resin a) is calculated by means of Fox's law:

$$\frac{1}{Tg} = {\sum }_{i}^{ } \frac{{w}_{i}}{{Tg}_{i}}$$

in which Tg and Tg are expressed in ° K
i refers to the monomer i, wᵢ is the mass fraction (by weight) in the copolymer and Tgᵢ is the Tg of the homopolymer of the monomer i. The sum of wᵢ is equal to 1.

TABLE 6
Tg values used in Fox's law for the homopolymers of the component
monomers

| | Tg Fox |
|---|---|
| Monomers | (° C.) |
| STY | 100 |
| BuA | −54 |
| HPMA | 72 |
| ISOBORMA | 170 |
| MAA | 228 |

### 5.5) Measurement of the Molecular Masses of the Polyol Acrylic Resin a)

They are obtained by analysis by size-exclusion chromatography (SEC or GPC) in THF. The analysis conditions used are as follows:
“low mass” columns (2 mixed columns D+1 100 Å column+1 50 Å column)
flow rate of mobile phase (THF): 1 ml/min, T°: 35° C., RI detection
calibration: PS standards (Mw: 371 100, 230 900, 96 000, 51 150, 21 810, 10 440, 4910, 3180, 1280, 580, 162 g·mol⁻¹).

### 5.6) Dust-Free Drying Test According to the Method ISO 1517

The principle is as follows: using fine calibrated glass beads (particle size 125/250 μm), the moment beyond which they no longer remain bonded to the support coated with paint or varnish is determined. The support coated with paint or varnish is placed in an air-conditioned room (50% RH/23° C.). After a certain time, at the end of which it is considered that the coating has sufficiently reacted, a spatula-full of glass beads (about 0.5 g) is taken and the beads are poured onto the applied paint (or varnish) using a small tube 10 cm long. After 10 seconds, the support is inclined by 20° and the glass beads are removed with a fine brush. If they do not remain bonded, the dry paint is considered to be “dust-free” at the corresponding drying time after application. In the opposite case, another test is performed a few minutes later and so on until no beads are bonded to the surface of the coating, to note the dust-free drying time.

### 5.7) Hardness Test Accordion to the Method ISO 1522

This is a Persoz hardness performed at 23° C. and at 50% relative humidity. The varnishes are applied to QD36-type steel (Q-Panel) and then left under the conditions described above (23° C. and 50% relative humidity) for a period of 7 days. The measurements are taken after 1 day, 3 days and 7 days of drying.

### 5.8) Calculation of the VOCs

The VOC content is the content in g/l of the volatile organic compounds as already defined in the description, and is equal to the weight percentage of said volatile compounds according to the definition of the diluent d) multiplied by the density (in g/ml) of the composition under consideration and by a factor of 10.

### 5.9) Application

The formulation of Example 1c is applied to a QD46-type steel support (Q-panel) with a Barecoater applicator (speed 3=20 mm/s) so as to obtain a controlled dry thickness of 40±5 μm. The varnish thus applied is conditioned at a temperature of 23° C., under a controlled relative humidity (RH) of 50%.

### Evaluation of the Performance Qualities and Results Per Formulation Tested

TABLE 7
Application performance qualities of the crosslinkable coating
composition of Example 1c

| | Properties of the coating |
|---|---|
| | of Example 1c |
| Thickness of the film on QD46 steel (μm) | 41 ± 1 |
| Dust-free drying (min) | 95 |
| Persoz hardness at 24 h (s) | 89 |
| Persoz hardness at 3 days (s) | 151 |
| Persoz hardness at 7 days (s) | 177 |

1. A polyol resin composition capable of reacting with isocyanate, comprising:
a) at least one polyol resin, obtained by polymerization of a mixture of ethylenically unsaturated monomers comprising a1) at least one hydroxylated ethylenically unsaturated monomer or a monomer that is a precursor of a hydroxylated unit, chemically modified during said polymerization or after, and a2) at least one ethylenically unsaturated monomer of cycloaliphatic structure, said resin a) having:
an OH number from 50 to 200 mg KOH/g,
an acid number <15 mg KOH/g,
a Tg calculated according to Fox of greater than 25° C.,
and an Mn from 1000 to 4000,
b) at least one reactive diluent bearing per molecule from 2 to 4 groups that are capable of reacting with an isocyanate group,
c) at least one urethanization reaction catalyst, optionally in the presence of a cocatalyst,
d) optionally, at least one diluent with a boiling point of less than 250° C., which is chosen from inert or unreactive diluents not bearing any group that can react with an isocyanate or from reactive monofunctional diluents bearing a group that can react with an isocyanate group,
e) optionally, at least one additive selected from the group consisting of UV stabilizer, antioxidant, pot life extender, conductivity additive and corrosion inhibitor with said composition having a content of compound d) corresponding to the content of volatile organic compounds of less than 300 g/l at 450 mPa·s at 25° C.

2. The composition as claimed in claim 1, wherein the weight content of said monomer a2) of cycloaliphatic structure is at least 5% and less than 80% by weight relative to the total weight of the monomers of said resin a).

3. The composition as claimed in claim 1, wherein said diluent b) has a Tg measured by DSC at 10° C./min after 2 passes of less than than 50° C.

4. The composition as claimed in claim 1 wherein said diluent b) is present such that the percentage weight ratio of b/(a+b+c+d+e) ranges up to 60%, with the sum of a)+b)+c)+d)+e) being equal to 100%.

5. The resin composition as claimed in claim 1 wherein said reactive diluent b) has a molecular mass not exceeding 1000 and a number average functionality ranging from 2 to less than 4.

6. The resin composition as claimed in claim 1 wherein said acrylic polyol resin a) is a copolymer derived from the radical polymerization in a diluent d) of a mixture of ethylenically unsaturated monomers, comprising, in addition to a1) and a2) as defined according to claim 1, a3) at least one comonomer selected from the other ethylenically unsaturated monomers, said mixture being based on (meth)acrylic monomers.

7. The composition as claimed in claim 1 wherein said polyol resin a) is present such that the weight ratio a/(a+b+c+d+e) ranges from 40% to 90%, with the sum of a)+b)+c)+d)+e) being equal to 100%.

8. The composition as claimed in claim 1 wherein said reactive diluent b) is selected from the group consisting of:
b1) polyol alkanes or polyamine alkanes bearing a linear or branched chain, which are alkoxylated or non-alkoxylated,
b2) polyols derived from natural oils or derivatives of the corresponding fatty acids,
b3) polyol oligoethers or oligoimine polyamines,
b4) polyol oligoesters,
b5) polyol oligourethanes, and
b6) polyoxazolidines.

9. The composition as claimed in claim 1 wherein said catalyst c) is chosen from the group consisting of:
c1) metal salts or metal complexes based on metals chosen from: Bi, Ti, Zn, Zr, Sn, and
c2) tertiary amines.

10. The composition as claimed in claim 1 wherein said diluent d) is chosen from the group consisting of:
d1) C₂-C₄ acid monoesters with alcohols (linear or branched),
d2) dicarboxylic acid diesters with C₁-C₄ alcohols,
d3) ketones,
d4) aromatic solvents,
d5) aliphatic alkane solvents a at least six carbons,
d6) mixed solvents comprising heteroatoms,
d7) monofunctional alcohols with a boiling point of <250° C., and
d8) a binary or ternary mixture of said solvents mentioned above, d1) to d7.

11. The composition as claimed in claim 1 wherein said polyol resin a) has a viscosity of from 500 to 5000 mPa·s at 25° C. for a weight content of resin of 70% (±1%) relative to the total resin+solvent.

12. A crosslinkable polyurethane composition comprising:
A) at least one polyol resin composition according to claim 1 that is reactive with a polyisocyanate B) as defined below
B) at least one polyisocyanate with a number-average functionality of NCO groups of at least 2, said polyisocyanate being optionally blocked and/or encapsulated.

13. The crosslinkable composition of claim 12 wherein the content of compounds d) corresponding to volatile organic compounds is less than 250 g/l.

14. The crosslinkable composition as claimed in claim 12 wherein said polyisocyanate is selected from the group consisting of aliphatic and cycloaliphatic polyisocyanates.

15. The crosslinkable composition as claimed in claim 12 wherein said polyisocyanate comprises an isocyanurate ring.

16. The crosslinkable composition as claimed in claim 12 wherein said polyisocyanate is aliphatic.

17. The crosslinkable composition as claimed in claim 12 wherein said polyisocyanate is an allophanate-modified polyisocyanate.

18. The crosslinkable composition as claimed in claim 17 wherein said polyisocyanate B) has a structure according to the general formula (I) below:
O═C═N—R₁—N(R₂)—C(═O)—NH—R₁—N═C═O (I)
with
R₁: C₆ alkylene or cycloalkylene,
R₂: —C(═O)—OR₃, with R₃ being a C₆ to C₃₆ alcohol residue.

19. The crosslinkable composition as claimed in claim 12 wherein said polyisocyanate is of cycloaliphatic structure.

20. A coating composition comprising at least one crosslinkable polyurethane composition according to claim 12.

21. (canceled)

22. (canceled)

23. The coating composition as claimed in claim 20 comprising one or more of: pigments, mineral fillers, rheology additives, wetting agents, dispersants, surface agents, UV stabilizers, antioxidants, corrosion inhibitors, moisture absorbers and anti foaming agents.

24. (canceled)

25. (canceled)

26. (canceled)

27. (canceled)

28. (canceled)

29. The polyol resin composition of claim 1, wherein said polyol resin a) is an acrylic resin and said monomers a1) and a2) are acrylic monomers.

30. The polyol resin composition of claim 1, wherein said polyol resin a) has an acid number <5 mg KOH/g and a Tg calculated according to Fox from 30 to 90° C.

31. The polyol resin composition of claim 1, wherein said reactive diluent b) bears 2 to 3 groups capable of reacting with an isocyanate.

32. The polyol resin composition of claim 1, wherein said urethanization reaction catalyst c) is nanoencapsulated and free of tin.

33. The polyol resin composition of claim 1, wherein said diluent d) is the residual polymerization solvent for said resin a).

34. The polyol resin composition of claim 1, wherein said urethanization reaction catalyst c) is chosen from the group consisting of c1) metal complexes of Ti and Zr, and c2) tertiary amines.
